(19) United States
(12) Patent Application Publication
(10) Pub. No.: US 2025/0135674 A1
(43) Pub. Date: May 1, 2025

(54) DIE-HOLDING CYLINDER FOR A LAMINATE DIE-CUTTING MACHINE

(71) Applicant: COMERCIAL INDUSTRIAL MAQUINARIA CARTON ONDULADO, S.L., Barcelona (ES)

(72) Inventors: Ramon SERRA OBIOL, Barcelona (ES); Jordi PUIG VARGAS, Barcelona (ES)

(21) Appl. No.: 18/722,857

(22) PCT Filed: Dec. 20, 2022
(86) PCT No.: PCT/ES2022/070825

§ 371 Date: Jun. 21, 2024

(30) Foreign Application Priority Data
Dec. 23, 2021 (ES) U202132520

(51) Int. Cl. B26D 7/26; B26F 1/38

(52) U.S. Cl. CPC B26D 7/2614; B26F 1/384; B26D 2007/2607

(57) ABSTRACT

The cylinder comprises a pneumatic system with a plurality of supply branches (A, B, C) provided for pressurized fluid delivery to retractable inserts (A1-A5), (B9-B10) and (C6-C8), such that a supply branch acts on a plurality of retractable inserts present in a first zone (or also referred to in this specification as a group) which is defined by a radial half of the cylindrical body, while a second and third zones of retractable inserts defined by radial portions of the other half of the cylindrical body are fed by supply branches (A, B, C).

It allows air pressure to be applied to the inserts of the two die halves without causing a second, previously fixed tile to fall out undesirably.

### OBJECT OF THE INVENTION

The present application refers to a die-holding cylinder for a laminate die-cutting machine.

More specifically, the invention proposes the development of a die-holding cylinder for a laminate die-cutting machine, particularly designed for die-cutting cardboard sheets for subsequent use in the packaging industry, featuring a pneumatic system that allows multiple operating modes.

### BACKGROUND OF THE INVENTION

In rotary die-cutting machines, the laminated material to be cut, for example, cardboard for the manufacture of boxes, moves between a rotatable die-holder cylinder, on which the die is mounted, and a counter-die cylinder or anvil, also rotatable, so that at each turn of the cylinders the die hits the counter-die and cuts or deforms the cardboard.

The dies can be attached to the die-holding cylinder by means of a holding system provided with a plurality of holding assemblies each having a retractable insert configured to protrude from the surface of the cylindrical body, being operable through a pneumatic system supplied by a pressurized fluid. This pneumatic system is formed by two branches for the pressurized fluid supplying a first and second group formed by a plurality of retractable inserts (preferably mushroom-shaped pins), each of the groups of retractable inserts being associated with one half of the cylinder.

The inserts provided are inserted into a pin hole made in the die. The pin of the inserts protrudes outwardly when pressure is applied to a bottom side of the insert. The pin is retracted by means of spring elements so that, in the absence of pressure, the pin holds the die firmly in the die-holding cylinder.

In this holding system, the first tile to be placed on the cylinder is the second tile (or tail tile). This tile abuts against bolts located at the “zero” of the cylinder. This point is important because it is the bolts that are loaded against the tangential forces during punching and not the pins of the inserts. Without these stops, the rod forming the pin can bend due to these tangential forces.

The first tile of the die (or head tile) is placed next and must touch and abut against the second tile previously mounted, so that the two halves remain as one continuous die.

The conventional pneumatic circuit acting on the inserts of the described holding system is divided into two branches, each feeding the inserts of one half of the cylinder.

If the second tile is short, the first tile is not held in place by all the available mushrooms (those in the second half of the cylinder now occupied by the first tile because the second tile is short). However, in order to use these inserts you would have to apply air pressure to the inserts in the two halves of the die, but this may cause the second tile previously fixed to fall undesirably, with the risk that it may break or hinder the previous preparation steps of the die on the die-holding cylinder.

Furthermore, the applicant is not currently aware of an invention having all the features described in this specification.

### DESCRIPTION OF THE INVENTION

The present invention has been developed with the aim of providing a die-holder cylinder which is a novelty within the field of application and solves the above-mentioned disadvantages, providing, in addition, other additional advantages which will be evident from the description below.

It is therefore an object of the present invention to provide a die-holding cylinder for a laminate die-cutting machine, comprising a cylindrical body provided for rotating about its longitudinal axis, and coupling means provided for coupling to dies consisting of a plurality of holding assemblies each having a retractable insert configured to protrude from the surface of the cylindrical body, being operable through a pneumatic system fed by a pressurized fluid. In particular, the invention is characterized in that the pneumatic system comprises a plurality of supply branches provided for the pressurized fluid conduction towards the retractable inserts, in such a way that a supply branch acts on a plurality of retractable inserts present in a first zone (or also referred to in this specification as a group) which is defined by a radial half of the cylindrical body, while a second and third zones of retractable inserts which are defined by radial portions present in the other half of the cylindrical body are supplied by supply branches.

In addition, valve means are provided linked to a control unit to control the fluid flow, such that through the valve means the pressurized fluid supply is selectively sent to one or more supply branches to operate the retractable inserts corresponding to the first zone, the second and third zones or the first and second zones, depending on the mounting requirements of the dies to be placed on the die-holding cylinder.

Preferably, the valve means comprise at least one non-return valve and a switch operable by a manually operated lever.

In a preferred embodiment, the pneumatic system has two pressurized fluid inlet supply branches, one of which is linked to the first zone and the second supply branch linked to the second and third zones.

In an alternative embodiment, the pneumatic system may comprise three pressurized fluid inlet supply branches, each of the supply branches being in fluid communication with a respective zone.

Thanks to these features, air pressure can be applied to the inserts of the two die halves, i.e., the holding system adapts to the die size in a simple and practical way, allowing the operation of a greater or lesser number of pins without the risk of a part of the die falling out.

The die-holder cylinder described therefore represents an innovative structure with structural and constitutive characteristics hitherto unknown for the purpose for which it is intended, reasons which, together with its practical utility, give it sufficient grounds to obtain the exclusivity privilege claimed.

Other features and advantages of the die-holding cylinder of the present invention will become apparent from the description of a preferred, but not exclusive, embodiment illustrated by way of non-limiting example in the accompanying drawings, in which:

### BRIEF DESCRIPTION OF THE DRAWINGS

FIG. 1.—It is a perspective view of a die-holding cylinder in accordance with the present invention;

FIG. 2.—It is a cross-sectional view of the die-holding cylinder in which some parts have been removed for illustrative purposes;

FIG. 3.—It is a schematic view of a pneumatic circuit forming part of the die-holding cylinder of the prior art;

FIGS. 4a-4c.—It is a sequential assembly view of a die part (or tile) in a die-holding cylinder according to the invention, including a detail view of the arrangement of the inserts in FIG. 4a; and

FIG. 5a-5c.—It is a sequential view showing the assembly of a second part (tiles) on the die part shown in FIG. 4;

FIG. 6.—It is a schematic view of a first embodiment of the pneumatic circuit forming part of the cylinder according to the invention; and

FIG. 7.—It is a schematic view of a second alternative embodiment of the pneumatic circuit forming part of the cylinder according to the invention.

### DESCRIPTION OF A PREFERRED EMBODIMENT

In view of the aforementioned figures and, in accordance with the numbering adopted, an example of a preferred embodiment of the invention, comprising the parts and elements indicated and described in detail below, can be seen in the figures.

Furthermore, the terms first, second, third and the like in the description and in the claims are used to distinguish between similar elements and not necessarily to describe a sequential or chronological order. The terms may be interchanged in appropriate circumstances and embodiments of the invention may operate in other sequences than those described or illustrated in the present specification.

Furthermore, the terms top, bottom, up, low and the like in the description and claims are used for descriptive purposes and not necessarily to describe relative positions.

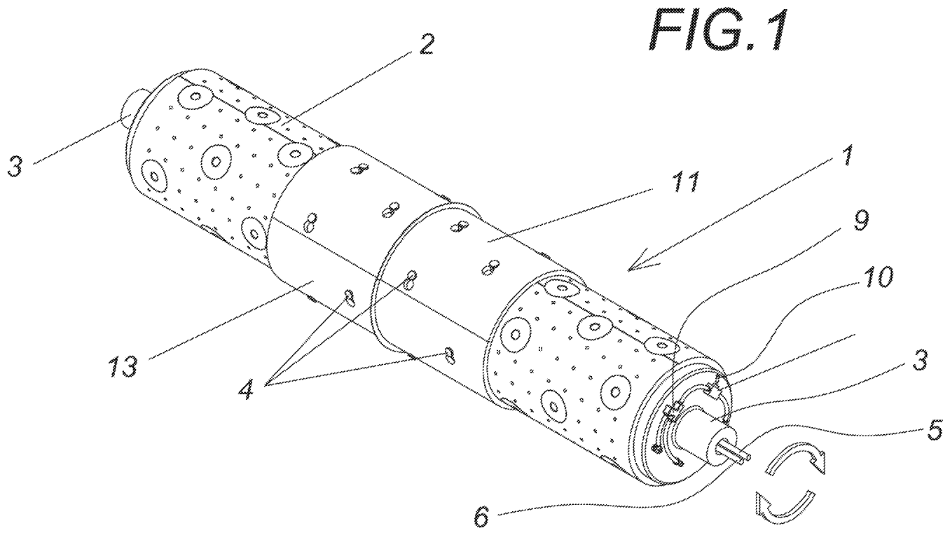

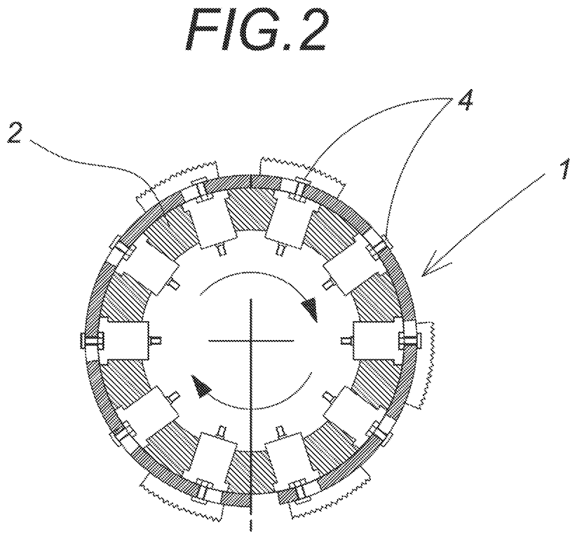

FIGS. 1 and 2 show a die-holding cylinder, generally indicated by reference (1), intended to form part of a laminate die-cutting machine (not shown), comprising a cylindrical body (2) provided to rotate about its longitudinal axis by means of a pivot shaft (3) at each end thereof. In addition, there are provided coupling means located inside the cylindrical body (2) which are provided for coupling to dies consisting of a plurality of holding assemblies each having a retractable insert (4) configured to protrude from the surface of the cylindrical body (2), being operable through a pneumatic system fed by a pressurized fluid.

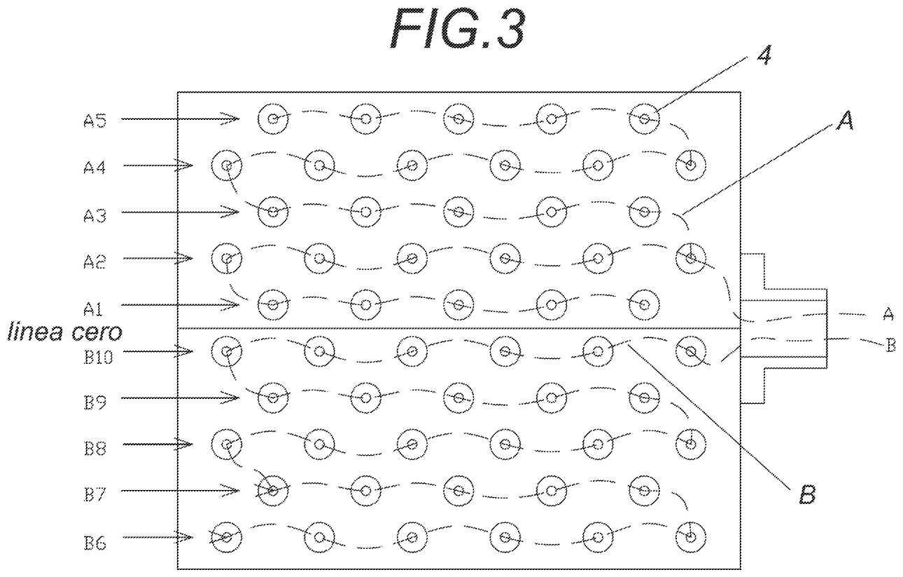

In FIG. 3, a pneumatic system known in the prior art essentially comprises two supply branches (A, B) for pressurized fluid conduction supplying a first and second groups (30, 31) formed by a plurality of rows of retractable inserts (A1-A5) and (B6-B10) respectively, each of the groups (30, 31) of retractable inserts being associated with a half of the cylinder (30, 31) defined in a fictitious way by the zero reference line (see FIG. 3). The supply branch (A) has an air supply line (5) while the supply branch (B) has an air supply line (6), both connected to a pressurized air supply source (not shown) external to the die-holding cylinder (1), preferably by means of a two-way rotary joint.

This system described in FIG. 3 works well when the first tile of the die to be placed has a half-circumference shape. However, if the first tile has an arc shape of considerably less than 180, the second tile to be laid is not completely fixed because the inserts of lines B6 and B7 have not been activated, otherwise the alignments (B8, B9 and B10) would also be activated, which would have caused the first tile to fall.

It should be noted that we will not go into further detail on the operation of the holding assembly as it is the same as the one described in document ES 2155334 of the same holder as the present application.

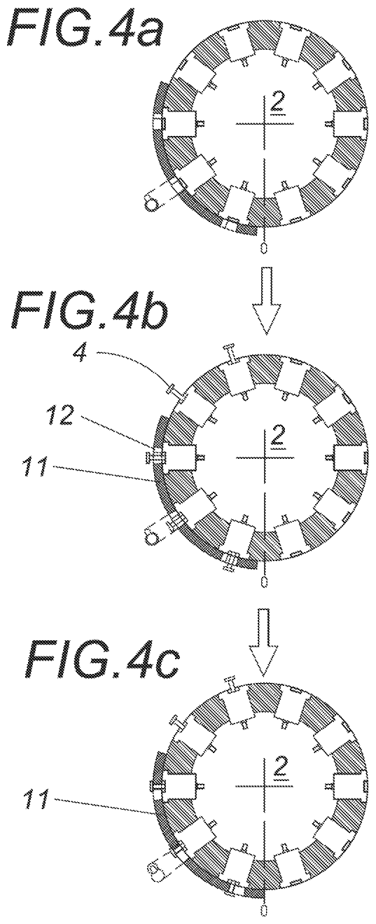

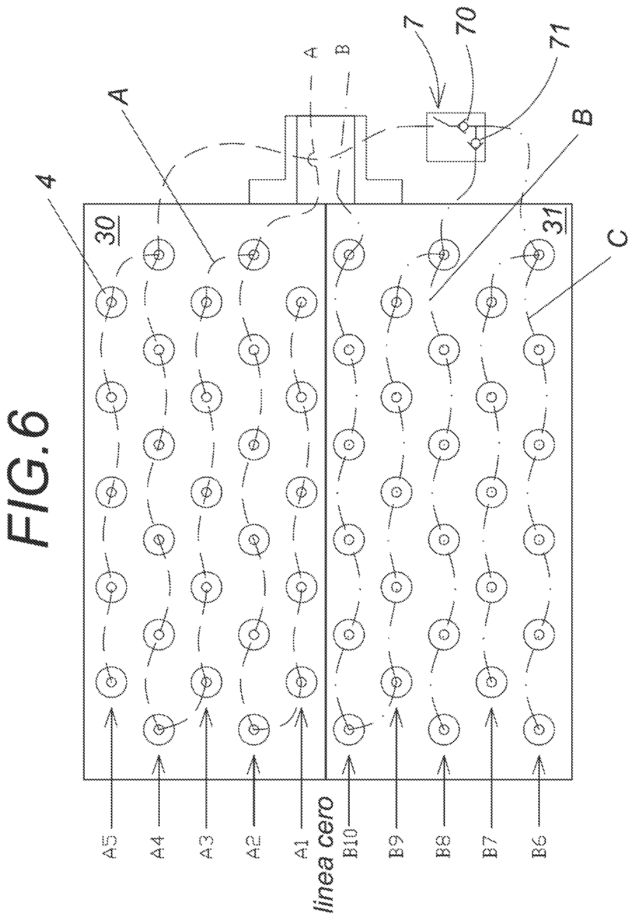

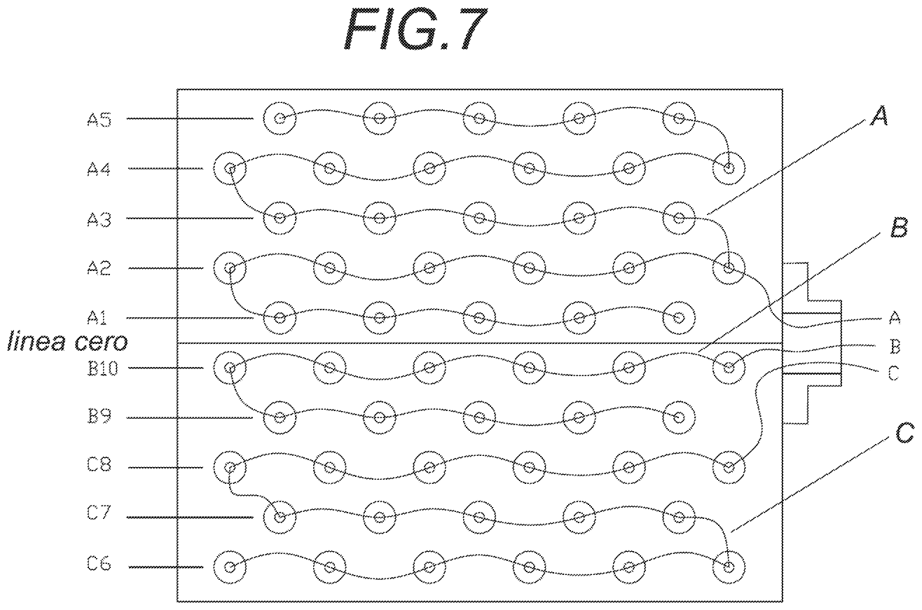

FIGS. 4a-c and 5a-c refer to the positioning of a die with the improved pneumatic circuit object of the invention of which two embodiments are proposed, a first preferred embodiment shown in FIG. 6 provided with two inlet branches, and the second embodiment shown in FIG. 7 provided with three inlet branches, as follows.

Referring now to FIGS. 4a-4c, the method of positioning a first die part (11) on the counter-die cylinder (1) is shown. Firstly, the die part (11) is placed on the counter-die cylinder (1) in such a way that the large diameter of the locking hole in the die part (11) matches with the position of the pin of the holding system (see FIG. 4a). Next, compressed air is applied to the inserts that are in contact with the die part (11), so that the pins exit through the large diameter of a corresponding keyhole (12) (see FIG. 4b). Finally, the die part (11) is rotated slightly so that the head of each of the pins is inserted into the smaller diameter of the keyhole (12) in the die part (11) and pressure is then removed from the inserts so that the die part (11) is firmly fixed in the die cylinder (1) (see FIG. 4c).

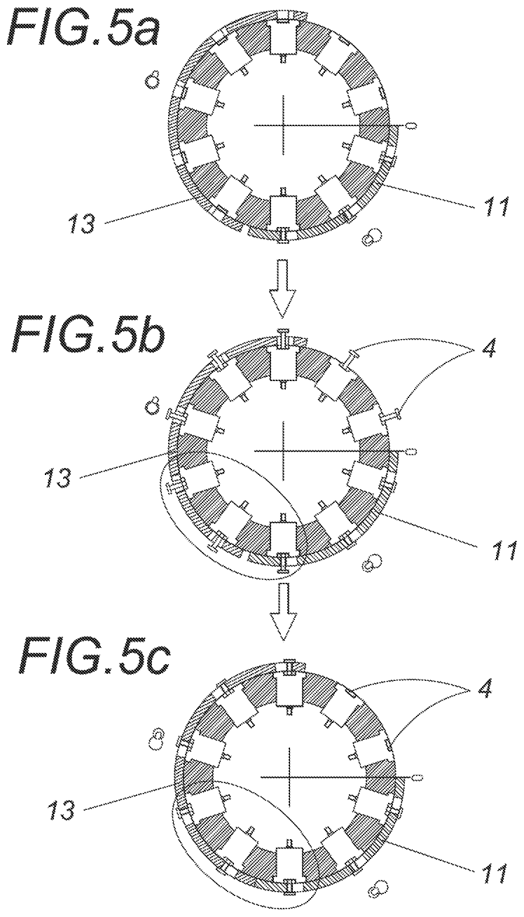

Now, referring to FIGS. 5a-5c, to place a second die part (13) in a die-holding cylinder as shown in FIG. 6 or 7, firstly, the die-holding cylinder (1) is rotated so that the operator can see the area of the die-holding cylinder (1) where the second die part (13) is to be placed. The second part of the die (13) is then positioned to match the large diameter of the keyhole (12) with the pin of the insert (4) (see FIG. 5a). Pressurized fluid is then applied to the inserts of the first half (30) inserted in the die with the switch (9) of the open circuit so that the pins of the first half plus those of the second half (31) of the die cylinder (1) indicated with a circle protrude outwardly. In this way, the die part (11) remains attached to the die cylinder (1) (see FIG. 5b). Finally, the second die part (13) is slightly rotated so that the head of the pin insert (4) is positioned in the small diameter of the keyhole (12) and pressurized air is removed from the inserts, so that the die part (11) and the second die part (13) are firmly fixed to the die-holding cylinder (1) (see FIG. 5c).

In a first preferred embodiment shown in FIG. 6, the die-holding cylinder (1) is provided with a pneumatic circuit with two supply branches (A, B) and a first and second groups (30, 31) of retractable inserts. One of the groups (31) in turn is formed by two subgroups. The supply branch (A) is in fluid communication with the supply branches (B) and (C) by means of valve means, generally indicated by the reference (7), which are linked to a control unit for controlling the fluid flow. More specifically, these valve means comprise non-return valves (70, 71) and a switch which can be operated by means of a manually operated lever. The combination and arrangement of these elements, as shown in FIG. 6, means that with the switch closed the behavior of the pneumatic circuit is the same as that of the conventional circuit shown in FIG. 3, i.e., the supply branch (A) acts on the inserts in zone 30 and the supply branch (B) acts on those in zone 31. On the other hand, if the switch is opened, branch B continues to act on the second group (31) in its entirety, but the supply branch (A) now acts on the first group (30) in its entirety plus lines B6 and B7 of the second group (31).

FIG. 7 shows a die-holding cylinder (1) provided with a pneumatic circuit with three independent supply branches (A, B, C) fed by the same external supply source, in such a way that three groups are established formed by a plurality of rows of retractable inserts (A1-A5), (B9-B10) and (C6-C8) respectively arranged parallel to each other in at least one longitudinal direction, (B9-B10) and (C6-C8) respectively arranged parallel to each other in at least one longitudinal direction, which will be driven individually or simultaneously depending on the needs and dimensions of the die to be mounted on the die-holding cylinder.

The details, shapes, dimensions, and other accessory elements used in the manufacture of the die-holding cylinder according to the present invention may be suitably replaced by others that do not depart from the scope defined by the claims below.

1. A die-holding cylinder for a laminate die-cutting machine, comprising a cylindrical body provided for rotation about its longitudinal axis, and coupling means provided for coupling to dies consisting of a plurality of holding assemblies each having a retractable insert configured to protrude from the surface of the cylindrical body, being operable through a pneumatic system supplied by a pressurized fluid, characterized in that the pneumatic system comprises a plurality of supply branches provided for pressurized fluid conduction to the retractable inserts, in such a way that a supply branch acts on a plurality of retractable inserts present in a first zone defined by a radial half of the cylindrical body, while a second and third zones of retractable inserts defined by radial portions present in the other half of the cylindrical body are supplied by supply branches, wherein valve means are provided linked to a control unit to control the fluid flow, such that through the valve means the pressurized fluid supply is selectively sent to one or more supply branches to operate the retractable inserts of the corresponding zones.

2. The die-holding cylinder according to claim 1, characterized in that the valve means comprise at least one non-return valve and a switch operable by means of a manually operated lever.

3. The die-holding cylinder according to claim 1, characterized in that the pneumatic system has two pressurized fluid inlet supply branches, one of them being linked to the first zone and the second supply branch linked to the second and third zones.

4. The die-holding cylinder according to claim 1, characterized in that the pneumatic system comprises three pressurized fluid inlet supply branches, each of the supply branches being in fluid communication with a respective zone.

5. The die-holding cylinder according to claim 1, characterized in that the retractable inserts are distributed on the body surface of the cylinder in a plurality of alignments running parallel to each other.
